(19) United States
(12) Patent Application Publication
(10) Pub. No.: US 2014/0117179 A1
(43) Pub. Date: May 1, 2014

(54) SIGNAGE DEVICES

(71) Applicant: IFCO SYSTEMS N.A., INC., Houston, TX (US)

(72) Inventors: William H. VALLS, Loveland, OH (US); Zachariah S. SIMMERING, Mansfield, OH (US)

(73) Assignee: IFCO SYSTEMS N.A., INC., Houston, TX (US)

(21) Appl. No.: 13/660,991

(22) Filed: Oct. 25, 2012

(51) Int. Cl. G09F 7/18; G09F 7/22

(52) U.S. Cl. 248/213.2; 248/309.1; 248/299.1

(57) ABSTRACT

The embodiments described and claimed herein are signage devices for reusable plastic containers (“RPC”) of the type that can be used by growers for shipping produce and by grocery stores for displaying and selling said produce. A first embodiment includes a spring-clip that attaches to a side wall of the RPC and a sign holder that can be rotated about a horizontal axis. A second embodiment includes a spring-clip that attaches to a side wall of the RPC and a sign holder that is oriented at a predetermined angle. A third embodiment includes an elongated spring-clip that attaches to a side wall of the RPC and an elongated, angled sign holder that is designed to hold signs that are scored along its length. A fourth embodiment sits in the interior volume of the RPC, divides the interior of the RPC into four compartments for different types of produce, and provides a sign holder for each of the four compartments. The fifth embodiment includes two spring-clip stems that are attach to the side wall of the RPC and hold a free-swinging signage panel that holds a sign on both its front and rear surfaces.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTIONS

1. Technical Field

The embodiments described and claimed herein relate generally to signage devices. More specifically, at least some of the embodiments described herein relate to signage devices that are designed for reusable plastic containers (“RPC”) of the type that can be used by growers for shipping produce and by grocery stores for displaying and selling said produce.

2. Background Art

Produce growers and retailers (e.g., grocery stores) use many diverse concepts for packaging, shipping, and displaying produce. The industry, however, has been trending toward the use of RPCs that are used for both shipping purposes and display purposes. RPCs are seen by some as the “wave of the future” because they are environmentally friendly and provide for significant supply chain cost savings compared to corrugated boxes. Indeed, the RPC or tray can be put directly on display tables or in refrigerated case, eliminating the need for the time-consuming process of removing produce from its packaging and setting the produce directly on the display table/refrigerated case. Unfortunately, some retailers, especially higher-end retailers, are reluctant to take advantage of the cost-saving and environmental benefits of RPCs because they associate the look of RPCs with lower-end or warehouse retailers.

### BRIEF SUMMARY OF THE INVENTIONS

The embodiments described and claimed herein are signage devices for RPCs that create the “high-end” or “farmers market” look and feel desired by some retailers. The various embodiments disclosed herein are minimally invasive in that they are designed so that the produce is not obscured or touched by the sign and the shopper is not impeded from accessing the produce in any way. The embodiments are also designed to allow efficient signage removal and attachment when switching out RPCs and to allow efficient sign removal and replacement when prices or produce items change.

In one particular embodiment, a signage device is provided that comprises a panel for holding a sign. The panel has at least one “c”-shaped sign holder formed from a first lip positioned opposite from a second lip and a raised rib positioned parallel to and between the first and second lips. The first lip, second lip, and raised rib triangulate the sign to keep the sign in place.

In another embodiment, a signage device is provided that comprises a sign holder for holding a sign. The sign holder comprises a first wall element adjacent a second wall element and a first rib on the first wall element positioned opposite from a second rib on the second wall element. The first wall element and the second wall element define a trough. The first rib is staggered from the second rib so that the sign is held by the sign holder at three distinct points, including at the trough, at the first rib, and at the second rib.

In yet another embodiment, a signage device is provided that comprises a panel having a first segment being oriented at an angle to a second segment. The first segment and second segment are generally planar. The first segment has a first lip and the second segment has a second lip to collectively define a “c”-shaped channel for holding a sign.

In yet another embodiment, a signage device is provided that comprises a divider having at least one wall member for dividing an interior volume of a tray into a plurality compartments. The divider supports at least one sign holder.

In yet another embodiment, a signage device is provided that comprises at least one support and a panel. The support rotatably supports the panel, whereby the panel is free-swinging. A first surface of the panel has a first “c”-shaped channel for holding a first sign and a second surface of the panel having a second “c”-shaped channel for holding a second sign.

Other embodiments, which include some combination of the features discussed above and below and other features which are known in the art, are contemplated as falling within the claims even if such embodiments are not specifically identified and discussed herein.

### BRIEF DESCRIPTION OF THE SEVERAL VIEW OF THE DRAWINGS.

These and other features, aspects, objects, and advantages of the embodiments described and claimed herein will become better understood upon consideration of the following detailed description, appended claims, and accompanying drawings where:

FIG. 1 is a perspective view of a first embodiment of a signage device;

FIG. 2 is a front view of the first embodiment;

FIG. 2A is a front view of the first embodiment with the C-channel removed;

FIG. 2B is a front partial-sectional view of an alternative clip stem for the first embodiment with the C-channel removed.

FIG. 3 is a side view of the first embodiment;

FIG. 4 is a side view of an alternative C-channel for the first embodiment;

FIG. 5 is a perspective view of a second embodiment of a signage device;

FIG. 6 is a side view of the second embodiment;

FIG. 7 is perspective view of a third embodiment of a signage device ;

FIG. 8A is a side view of the third embodiment;

FIG. 8B is a side view of an alternative construction of the third embodiment;

FIG. 9 is a perspective view of a fourth embodiment of a signage device;

FIG. 10 is close-up perspective view of a sign holder of the fourth embodiment;

FIG. 11A is a side view of the sign holder of the fourth embodiment;

FIG. 11B is a side partial-sectional view of an alternative sign holder of the fourth embodiment;

FIG. 12 is a perspective view of a panel, two of which are used to form the divider of the fourth embodiment;

FIG. 13 is a front view of the panel of the fourth embodiment;

FIG. 14 is a top view of the panel of the fourth embodiment;

FIG. 15 is a cross-sectional view of the panel of the fourth embodiment taken along the plane indicated in FIG. 13;

FIG. 16 is a perspective view of a fifth embodiment of a signage device;

FIG. 17 is a front view of the fifth embodiment;

FIG. 18 is a side view of the fifth embodiment;

FIG. 19A is a cross-sectional view of the swinging signage panel of the fifth embodiment taken along the plane indicated in FIG. 17;

FIG. 19B is a cross-sectional view of an alternative swinging signage panel of the fifth embodiment; and,

FIG. 20 is a perspective view of the clip stem of the fifth embodiment with the signage panel removed.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from Figure to Figure in the following detailed description of the drawings.

### DETAILED DESCRIPTION OF THE INVENTIONS

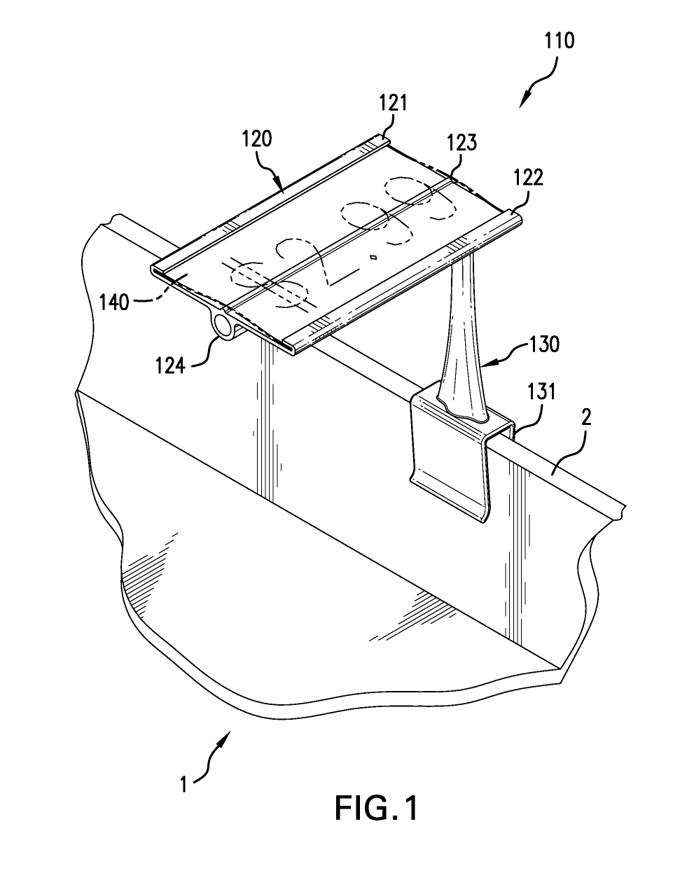

Referring first to FIGS. 1-4, a first embodiment of a signage device 110 for a tray 1 is shown. The first embodiment of the device 110 includes a C-channel 120 and a clip stem 130. The C-channel 120 is formed by extrusion and the clip stem 130 is injection molded, although it is contemplated that other methods of manufacture can be used.

The C-channel 120 is a printed sign holder with a first return lip 121 at the top edge and second return lip 122 at the bottom edge for sign 40 retention and includes a raised rib 123 on the top surface to create friction when the sign 40 is slid into the C-channel 120. This rib 123 in effect triangulates the tension between the sign 40 (signs are routinely removed and replaced) and the extrusion. The return lips 121, 122 are approximately parallel to the top surface of the C-channel, but can be biased toward the top surface for greater sign 40 retention as reflected by the lips 121a, 122a in FIG. 4. The C-channel 120 extrusion also includes an integral tubular element 124 on the bottom surface. The cross-section of the tubular element 124 is a circular in shape, although other shapes can be used (e.g., square, oval, etc.). Further, the cross-section of the tubular element 124 forms a closed loop, although it is contemplated that the loop can be “open” for a fraction of the circumference, as demonstrated by tubular element 124a in the C-Channel 120a shown in FIG. 4. Because the C-channel 120 is formed through a mandrel, the C-channel component 120 is consistent in its cross-section throughout its length, only being cut to the length required for signage purposes. In that respect, the first and second return lips 121, 122, the rib 123, and the tubular element 124 extend the entire length of the C-channel 120. Should other methods of manufacture be used, it is contemplated that the C-channel 120 cross section can vary through its length/width.

The clip stem 130 has a spring-loaded clip 131 (featured by inward angled walls) molded at the bottom edge of the clip stem 130 that allows the clip stem 130 to attach to the tray 1 at the top end of the tray wall 2. Above the clip 131 is a stem 132 with an inverted “L” shape that transitions from a wider shaped geometry at its base 133 to a round shaft at its proximal segment 134 and distal segment 135. In other words, the cross section of the stem 132 at its base 133 is greater than the remaining segments of the stem 132. The wider shaped geometry at the base 133 of the stem 132 offers greatly increased strength between the clip 131 and stem 132, thus inhibiting stress at the intersecting point between the stem 132 and clip 131 of the device 110.

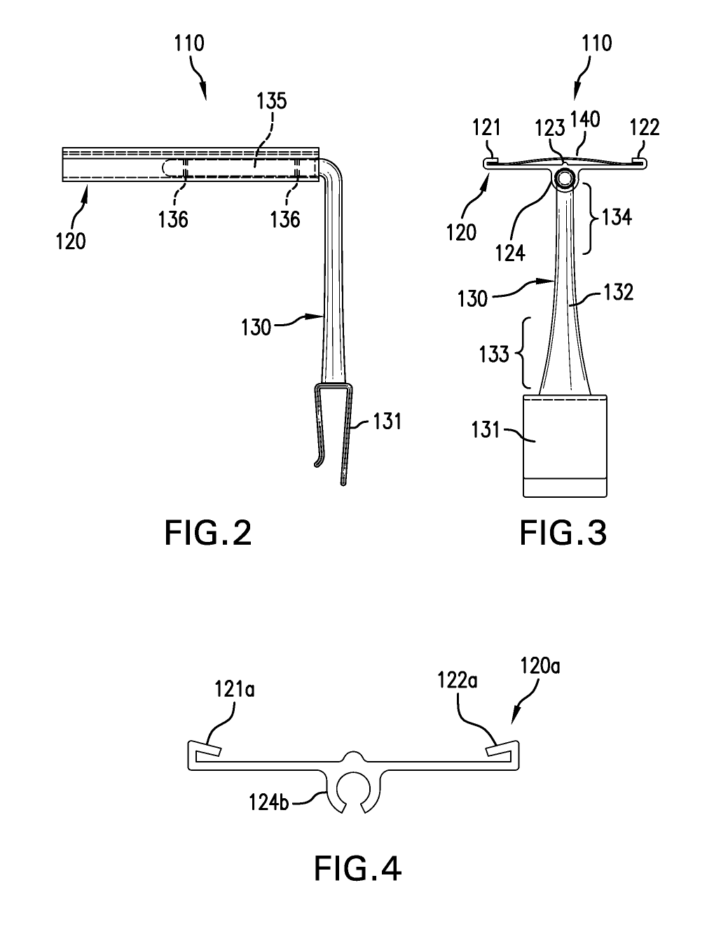

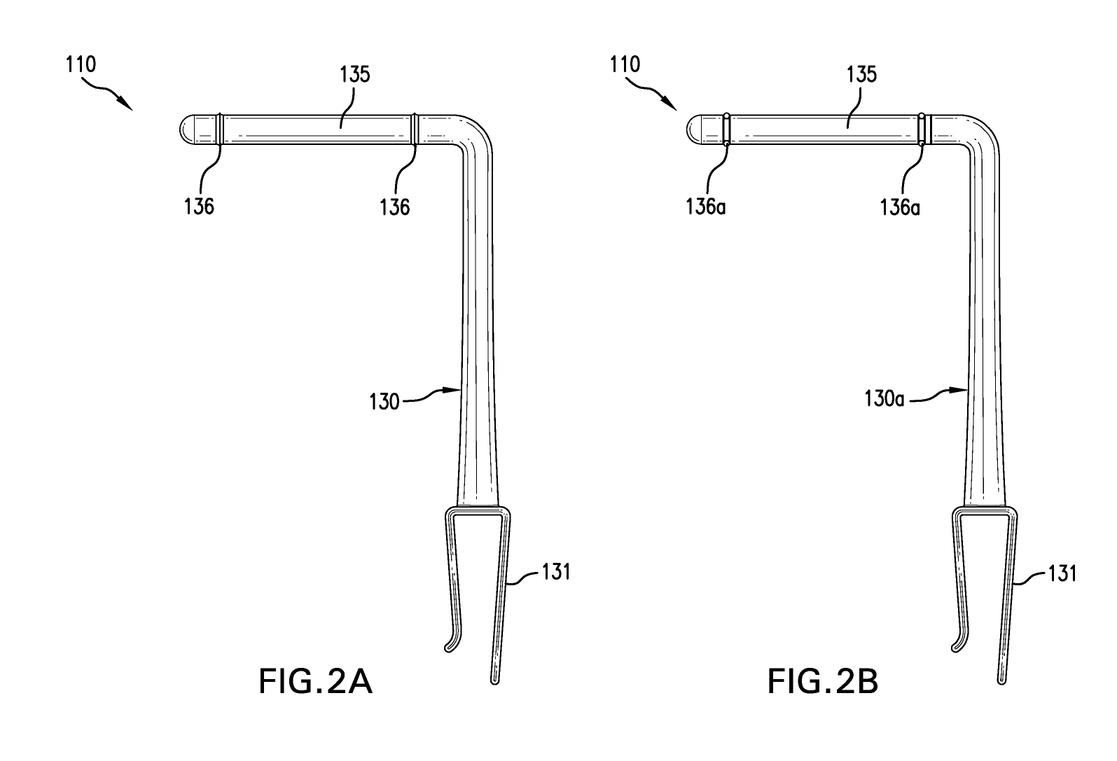

The distal segment 135 of the stem 130 also has two raised and tapered vanes 136 that also provide resistance friction so the signage C-channel 120 won't spin or flop over and hide the graphics on the sign. Since the vanes 136 are tapering from a small base dimension down to a tight corner at the top of the vane 136, some measurable deflection will occur and provide needed resistance without jamming the C-channel 120 too tightly. As shown in FIG. 2B, it is contemplated that the vanes 136 can be replaced with channels in which O-rings 136a will sit to provide the necessary friction. This friction provided by the vanes 136 (or O-rings 136a) also allows the device 110 to be positioned on either the left or right sides of the tray 1 and obviates the need for left-side-only or right-side-only devices (eliminates inventory issues), which makes the installation and servicing of these signage devices 110 considerably easier for the grocery sales associates.

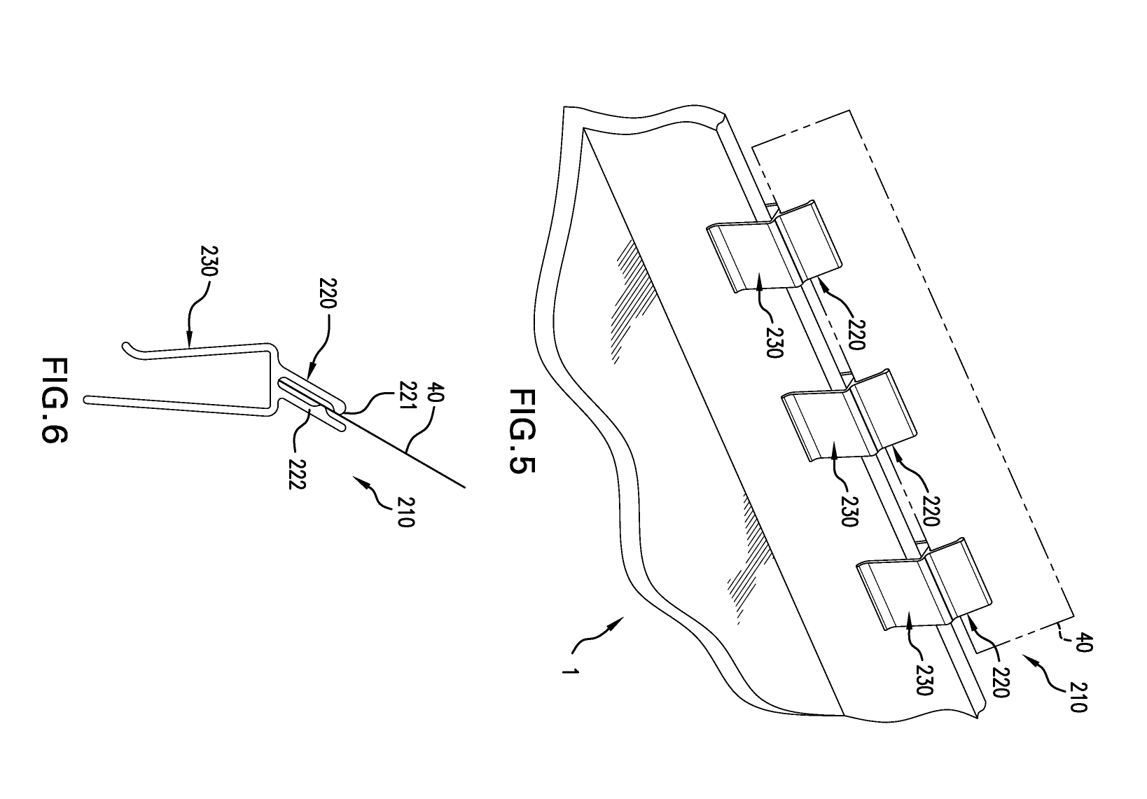

Referring now to FIGS. 5-6, a second embodiment of a signage device 210 for a tray 1 is shown. The second embodiment of the device 210 is a small, extruded clip that attach to the wall 2 of a tray 1 anywhere along the top end and are held in place by the spring tension of the clip design (featuring inward angled walls). However, it is contemplated that other methods of manufacture may be used, other than extrusion. The device 210 includes an angled sign holder 220 and a spring-loaded clip 230.

The angled sign holder 220 includes two opposing ribs 211, 212 which are designed to firmly hold a sign 40 in place. The opposing inward-facing ribs 211, 212 create a triangulating resistance that allows one or more devices to hold a given sign 40 at the desired angle for consumer viewing (three devices are shown in FIG. 5). The ribs 40 are staggered so the sign is held at 3 distinct points: in the center where the ribs 221, 222 are molded and at the bottom of the holder 220 trough. A single device 220 can hold smaller signs 40, such as 3.00″×5.00″, or several devices 220 can hold longer and wider signs, for example 3 devices 220 typically hold a sign that is 3.00″×14.00″.

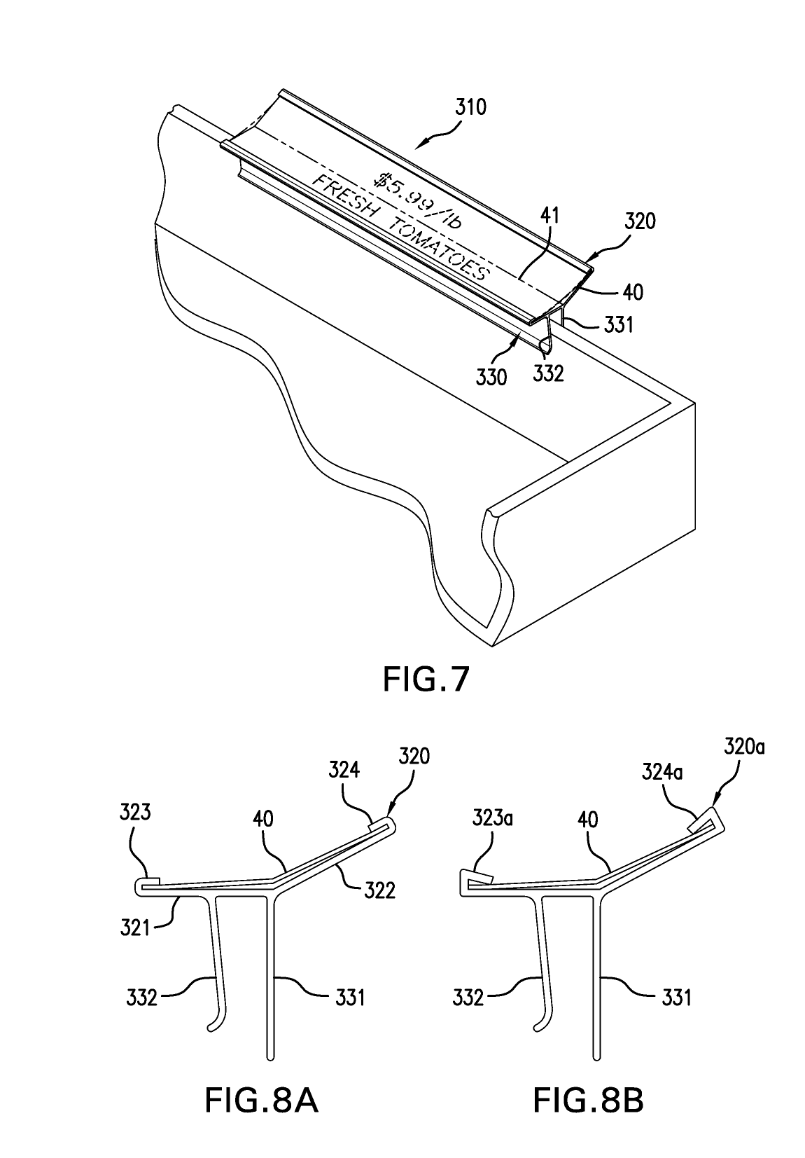

Referring now to FIGS. 7-8, a third embodiment of a signage device 310 for a tray 1 is shown. The device 310 is an extrusion. However, it is contemplated that other methods of manufacture may be used, other than extrusion. Although the device 310 may be cut to any length, it is contemplated that the device 310 will be designed to accommodate signs 40 along either a shorter or the longer wall 2 of a tray 1 measuring 40 cm by 60 cm. Accommodating both length sides of such a tray 1 is important to provide the flexibility needed in a retail environment. The third embodiment of the device 310 includes a C-channel 320 and a spring-loaded clip 330.

The C-channel 320 is angled in the center so that the graphic sign 40 can have a score 41 down the length of it. This provides physical distinction for the organization of graphic elements (e.g., price above the score 41 and a description below the score 41). Non-scored cards 40 will also fit this angled channel by draping in a curved graphic presentation. The C-channel 320 is formed from a first wall segment 321 and a second wall segment 322. Each of the segments 321, 322 include a lip 323, 324 for sign retention. The lips 323, 334 are approximately parallel to their respective segment 321, 322, but can be biased toward the respective segment 321, 322 for greater sign 40 retention as reflected by the lips 323a, 324a in FIG. 8B.

On the bottom of the extrusion there is a full-length spring-loaded clip 330 that secures the device 310 to the tray 1. Given the length of the device and its typical positioning at the rear of the tray, the spring clip has a vertical rear wall 331 and an angled front wall 332. This asymmetry allows the device 310 to stay positioned vertically when attached to the tray 1 and not tip forward.

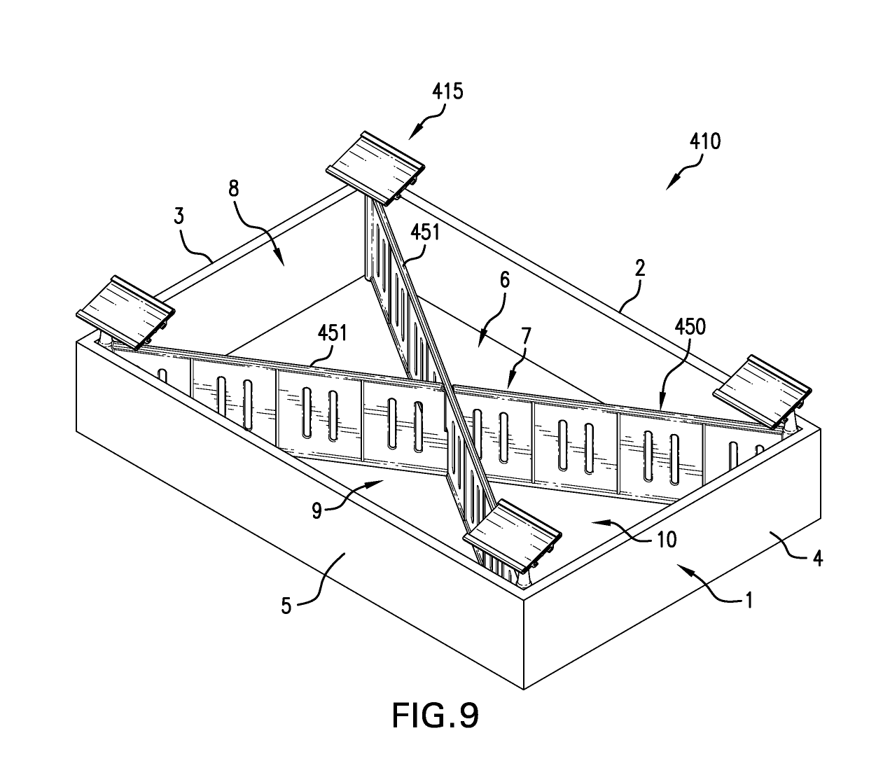

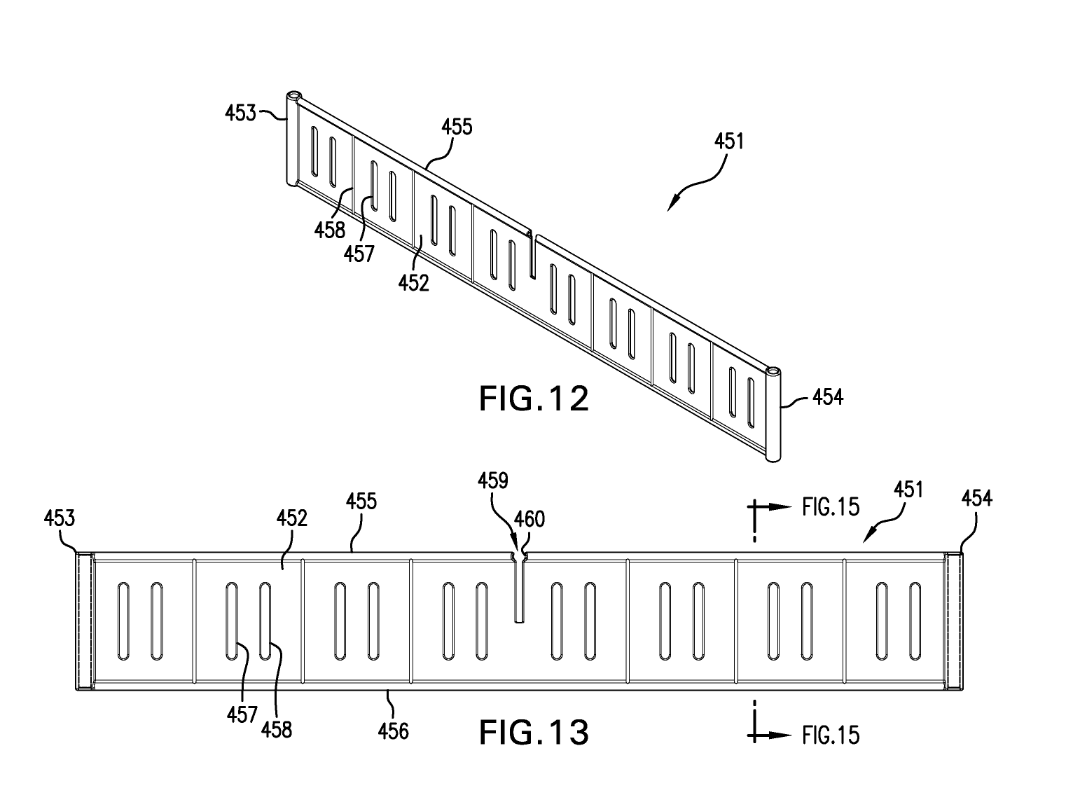

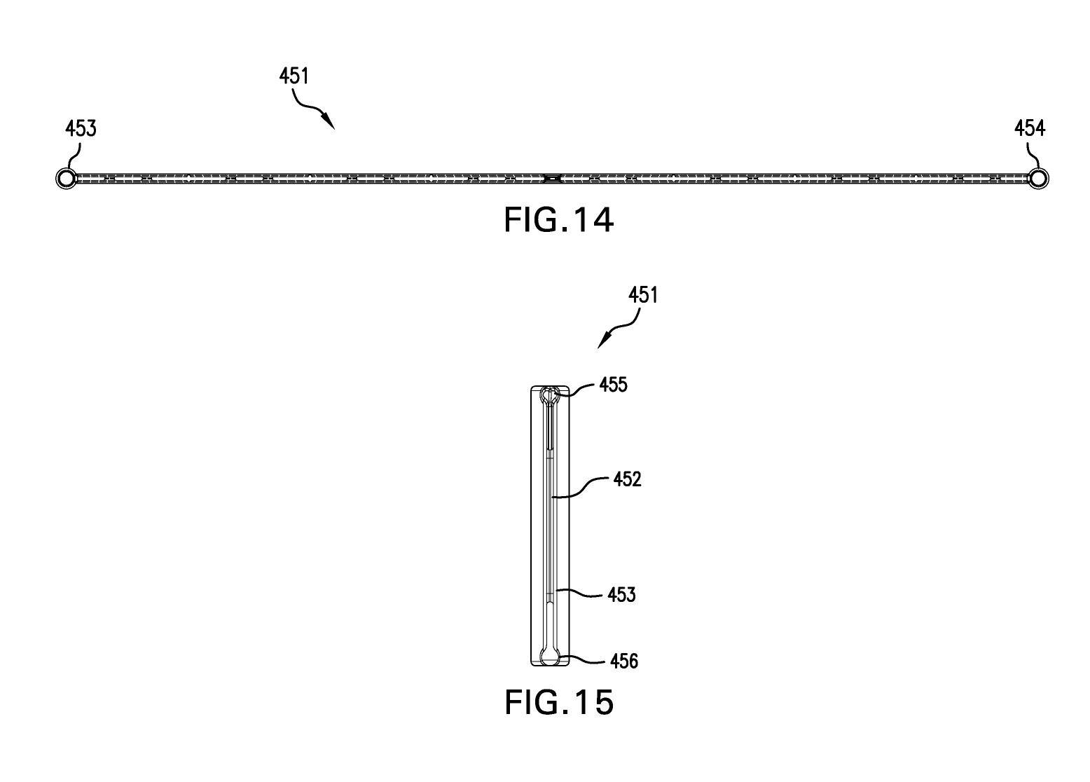

Referring now to FIGS. 9-15, a fourth embodiment of a signage device 410 for a tray 1 is shown. The signage device 410 was created to not only provide a mechanism for displaying signage 40, but also to segment the volume 6 of tray 1 (that is bounded by walls 2, 3, 4, 5) into four smaller, triangular compartments 7, 8, 9, 10, that can accommodate smaller produce items such as jalapeños, cherries, plantains, peppers, etc. The fourth embodiment of the device 410 includes at least one and preferably four sign holders 415 and a divider 450.

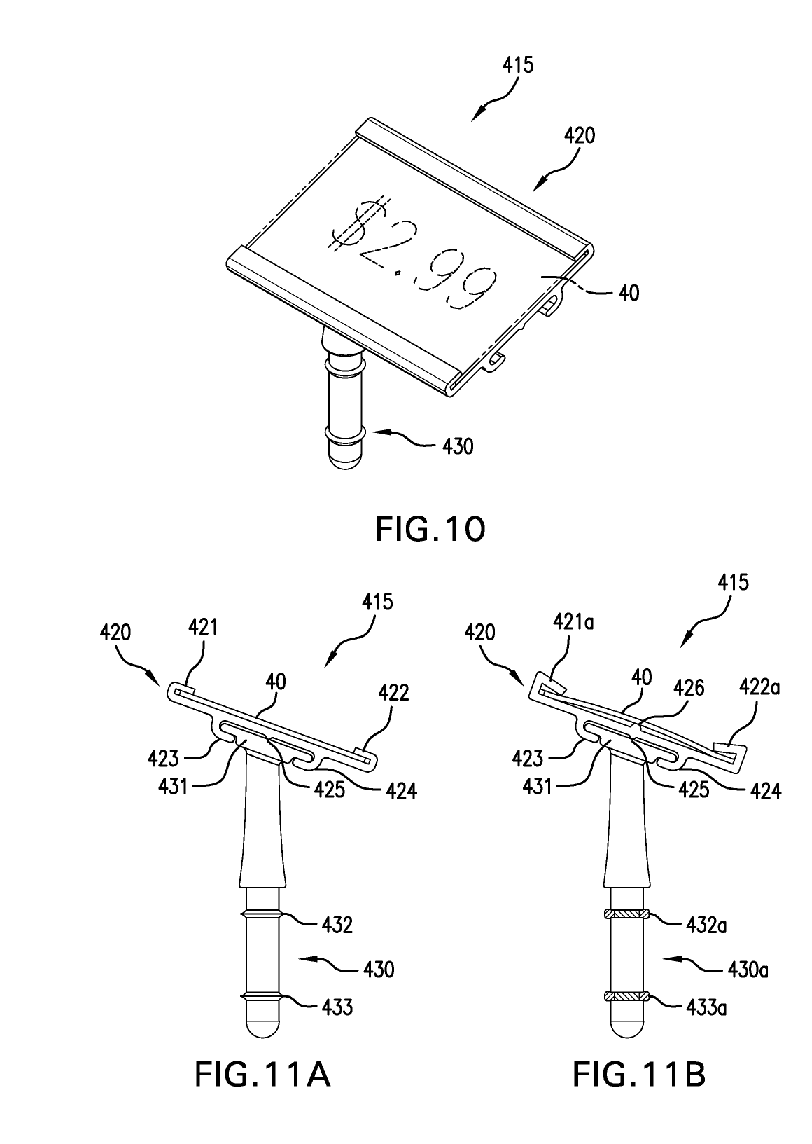

With particular reference to FIGS. 10-11, each sign holder 415 includes a double-C-channel 420 and a mounting post 430. The double-C-channel 420 includes a first C-channel on its top surface for holding a sign 40 and a second C-channel on its bottom surface for attaching to the mounting post 430. The double-C-channel is extruded. However, it is contemplated that other methods of manufacture may be used, other than extrusion. The double-C-channel 420, on its top surface, is a printed sign holder with a first return lip 421 at the top edge and second return lip 422 at the bottom edge for sign 40 retention. The lips 421, 422 are approximately parallel to the top surface of the double-C-channel 420, but can be biased toward the top surface for greater sign 40 retention as reflected by the lips 421a, 422a in FIG. 11B. The double-C-channel 420 can also include rib 426 on its tops surface to triangulate the sign 40, as shown in FIG. 11B. At its bottom surface, the double-C-channel 420 includes a third lip 423 and a fourth lip 424 for engaging with the mounting post 430. The bottom surface of the double-C-channel 420 includes at least one raised rib 425 located between the third and fourth lips 423, 424 that creates friction when the mounting post 430 is engaged with the double-C-channel 420. The rib 425 acts as locking details so the double-C-channel won't slide off the mounting post 430 at retail, thus disrupting the produce communication dynamic at retail. The rib 425 allows the double-C-channel 420 to be held stationary on the mounting post, either centered above the mounting post 430 or biased to the left or right of the mounting post 430.

Each signage mounting post 430 has relevant details at each end of the post 430. At the top there is a plate 431 molded at approximately a 15° angle so the signage is correctly positioned for consumer viewing when the device 410 and tray 1 are displayed in an angled refrigerated case (e.g., refrigerated produce display at a grocery store). The plate 431 can be oriented at other angles depending upon the application. At the bottom of the post 430 where the post enters tubular openings 453, 454 of the divider 450, there are two molded-in vanes 432, 433 that deflect to provide enough friction to allow the signage to be positioned and remain in place for consumer viewing. As refected in FIG. 11B, it is contemplated that the vanes 432, 433 can be replaced with channels in which O-rings 432a, 433a will sit to provide the necessary friction.

With particular reference to FIGS. 9 and 13-15, the divider 450 includes two identical panels 451 comprising a wall member 452, a first tubular opening 453 at one end of the wall member 452 and a second tubular opening 454 at the opposite end of the wall member 452, a top edge bead 455 running along the top edge of the wall member 452, a bottom edge bead 456 running along the bottom edge of the wall member 452, a plurality of ventilation slots 457 along the length of the wall member 452, a plurality of bead elements 458 extending from the top edge bead 455 to the bottom edge bead 456, a mating slot 459 at the mid-point of the panel 451.

The plurality of ventilation slots 457 that provide needed ventilation when the divider 450 and tray 1 is located in the refrigerated (and frequently hydrated) areas in a grocery store produce department. The raised bead elements 458 that serve several functions, including improved material flow in the injection mold, increased strength-to-weight ratios since the bead allows the panels to be thinner in cross-section, and offer locking surface geometry for the panels.

The mating slot 459 is open at one end across the narrow dimension of the panel 451 and bisects the length-wise edge. The slot 459 has a flat interior end to it. It is this slot 459 that mates to the identical second panel 451 (which is inverted), thus forming the titular X shape device 410. The opening 460 of this mid-point slot 459 has a ‘flower-petal-like’ shape to its geometry where the open-faced shapes are intended to accept and interlock with the bottom edge bead 456 of the mating panel 451. This interlock is intended to provide a narrow range of motion to the assembled X-wing panels so that they will not rotate relative to each other over a wide range and make installation by the sales associate more difficult (thus leading to a failed installation and discarding of the device).

The tubular openings 453, 454 at each end of the panel allow signage mounting posts 430 to be inserted from either side. Each complete assembly will include four signage posts and four double-C-channel sign holders 420.

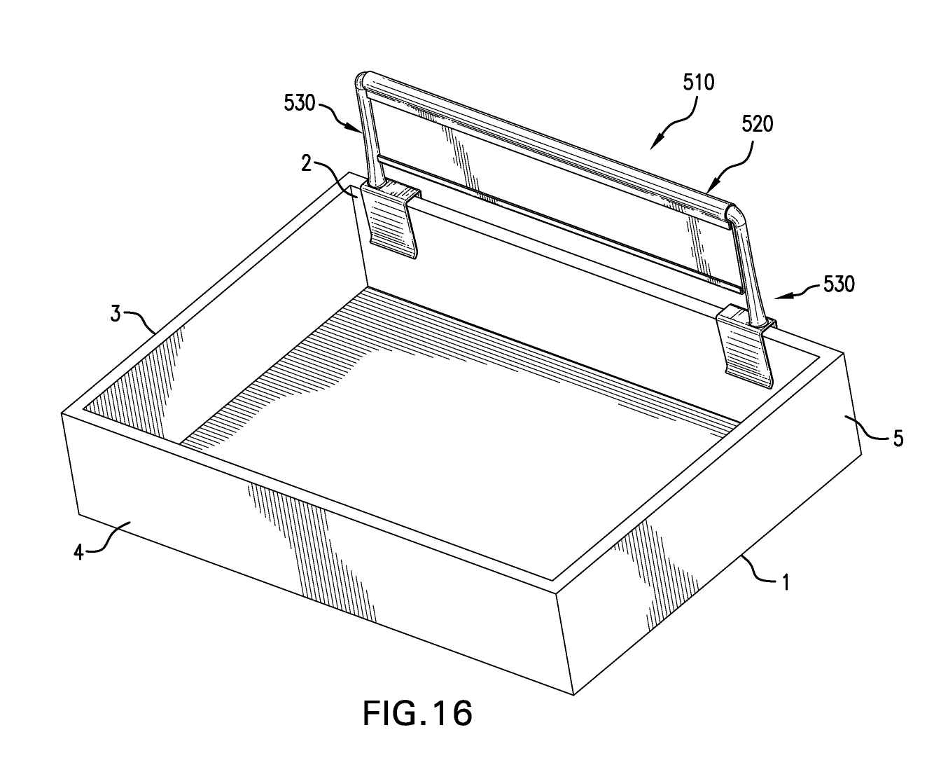

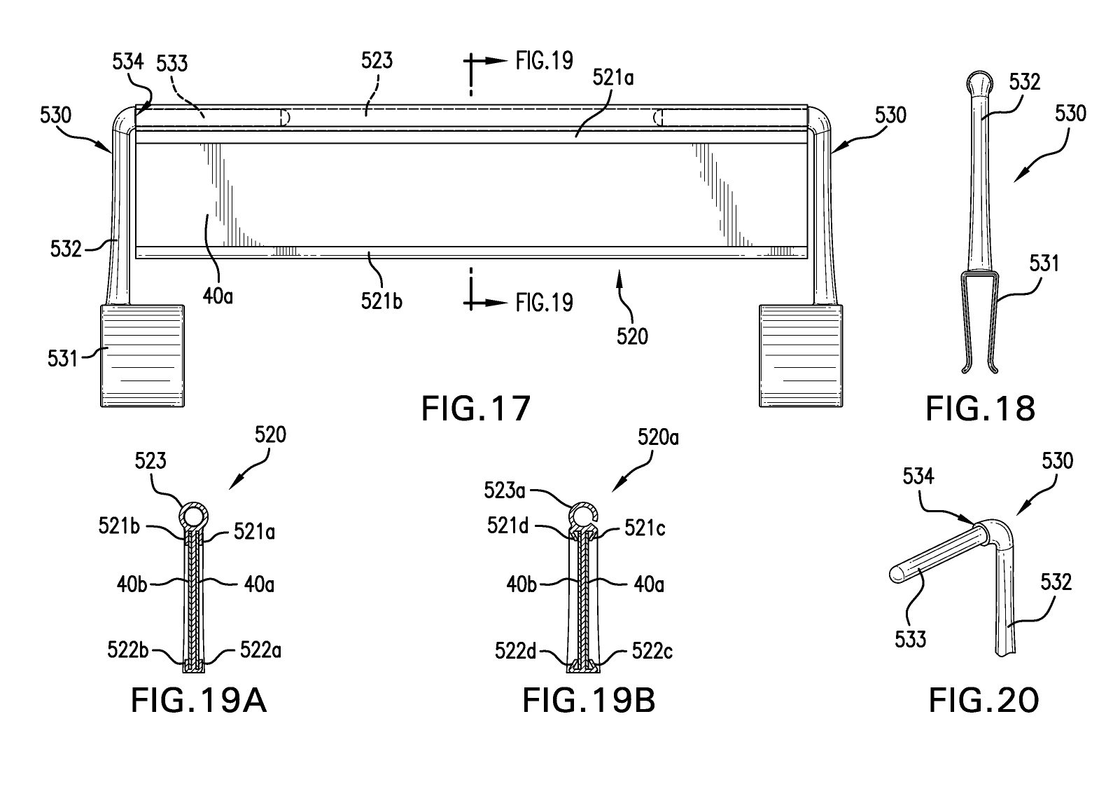

Referring now to FIGS. 16-20, a fifth embodiment of a signage device 510 for a tray 1 is shown. The fifth embodiment 510 is designed to be compatible with trays that may in some cases be set on a horizontal surface and in other cases on an inclined surface. In order to accommodate display surfaces of varying inclinations, the fifth embodiment of the signage device 510 is comprised of a free-swinging signage panel 520 that is supported at each end by a clip stem 530. The assembled device 510 is intended for either front or back walls 2, 4, as well as left or right walls 3, 5 of the tray 1.

As best shown in FIG. 19A, the signage panel 520 is double sided, by extruding C-channels with a top lip 521a, 521b and a bottom lip 522a, 522b on both sides of the signage element. This allows grocers to display specific produce item graphic on the front sign 40a (facing the produce in the tray) and more general, freshness-oriented communications on the back sign 40b of the panel 520. The lips 521a, 521b, 522a, 522b are approximately parallel to the wall member of the signage panel 520, but can be biased toward the wall member for greater sign 40 retention as reflected by the lips 521c, 521d, 522c, 522d in FIG. 4. Across the top of the graphic panel is an integrally extruded tube 523 that allows the clip stems 530 to be introduced and secure the panel, and allow it to swing freely. The tube 523 can be formed from a closed loop or as an open loop, as reflected by tube 523a for the signage panel 520a in FIG. 19B.

The clip stems 530 are injection molded as two identically inverted-L-shaped arms so the need for left/right orientation in not needed. The clip 531 located at the base of the post 532 is thus symmetrical across their centerline and can mount equally well on either side, or front or back tray wall. The walls of the clip 531 are inwardly directed to grip the side wall of the tray 1. The arm 533 that inserts into the tube 523 does not have friction vanes (as in other device descriptions) so the panel 520 can seek its own center-of-gravity and always hang straight (perpendicular to the store floor).

In order to achieve the widest signage panel possible, the post 532 is narrowed (compared to the previous embodiments) and positioned at the outer edges of the spring clip 531. This allows the panel 520 (and thus the signs 40a, 40b) to be wider and still provides a strong clip-post interface in the injection-molded component.

The arm 533 that slides into the tube 523 of the panel 520 has a step increase in diameter near the arm/post interface to form a shoulder 524 that prevents the arm 533 from sliding too far into the tube 523 and jamming at the 90 degree bend.

Although the inventions described and claimed herein have been described in considerable detail with reference to certain embodiments, one skilled in the art will appreciate that the inventions described and claimed herein can be practiced by other than those embodiments, which have been presented for purposes of illustration and not of limitation. Therefore, the spirit and scope of the appended claims should not be limited to the description of the embodiments contained herein.

We claim:

1. A signage device comprising:
a panel for holding a sign, the panel having at least one “c”-shaped sign holder formed from a first lip positioned opposite from a second lip and a raised rib positioned parallel to and between the first and second lips, whereby the first lip, second lip, and raised rib triangulate the sign.

2. The signage device of claim 1, further comprising a support, the support having a spring-clip for removable attachment to a side wall of a tray.

3. The signage device of claim 2, wherein the panel is rotatably attached to the support.

4. The signage device of claim 3, wherein the panel rotates relative to the support about a horizontal axis.

5. The signage device of claim 2, wherein the support has a stem that extends from the spring-clip at one end and connects to the panel at a second end, the stem having a base segment, a proximal segment, and a distal segment.

6. The signage device of claim 5, wherein the base segment has a first cross-sectional area and the proximal segment has a second cross-sectional area, the first cross-sectional area being generally larger than the second cross-sectional area.

7. The signage device of claim 5, wherein the distal segment is generally perpendicular to the proximal segment.

8. The signage device of claim 5, wherein the panel includes a tube that receives the distal segment of the support.

9. The signage device of claim 8, wherein the distal segment includes at least one vane that frictionally engages with the tube to retain the panel at a user-desired angle.

10. The signage device of claim 1, wherein the first lip, the second lip, and the raised rib have a continuous cross-section across an entire length of the panel.

11. A signage device comprising:
a sign holder for holding a sign, wherein the sign holder comprises a first wall element adjacent a second wall element and a first rib on the first wall element positioned opposite from a second rib on the second wall element, the first wall element and the second wall element defining a trough, whereby the first rib is staggered from the second rib so that the sign is held by the sign holder at three distinct points, including at the trough, at the first rib, and at the second rib.

12. The signage device of claim 11, further comprising a spring-clip depending from the sign holder, the spring-clip being for removable attachment to a side wall of a tray.

13. The signage device of claim 12, wherein the sign holder and the spring-clip have a continuous cross-section across an entire length of the signage device.

14. A signage device comprising:
a panel having a first segment being oriented at an angle to a second segment, the first segment and second segment being generally planar, the first segment having a first lip and the second segment having a second lip to collectively define a “c”-shaped channel for holding a sign.

15. The signage device of claim 14, wherein the panel is elongated.

16. The signage device of claim 14, further comprising a spring-clip depending from the panel, the spring-clip being for removable attachment to a side wall of a tray.

17. The signage device of claim 16, wherein both the panel and the spring-clip have a continuous cross-section across an entire length of the signage device.

18. The signage device of claim 16, wherein the spring-clip depends from the first segment of the panel.

19. The signage device of claim 19, wherein the spring-clip comprises a first wall and a second wall, at least one of the first wall or second wall being perpendicular to the first segment.

20. A signage device comprising:
a divider comprising at least one wall member for dividing an interior volume of a tray into a plurality compartments; the divider supporting at least one sign holder.

21. The signage device of claim 20, wherein the divider includes at least one tube for receiving a post of the at least one sign holder.

22. The signage device of claim 21, wherein the post includes at least one vane that frictionally engages with an inner surface of the tube to retain the sign holder at a user-desired position.

23. The signage device of claim 20, wherein the at least one sign holder includes a panel for holding a sign and a support for the panel, an underside of the panel having a “c”-shaped channel for receiving a plate member of the support, the “c”-shaped channel being formed from a first lip positioned opposite from a second lip and a raised rib positioned parallel to and between the first and second lips, whereby the first lip and second lip receive opposite edges of the plate member and the raised rib frictionally engages with a surface of the plate to retain the panel at a user-desired position relative to the support.

24. The signage device of claim 20, wherein the at least one wall member includes a first wall member that is identical to a second wall member.

25. The signage device of claim 24, wherein the first wall member and the second wall member each include a slot extending from a top edge to approximately a midpoint between the top edge and a bottom edge, whereby the slot of the first wall member interlocks with a slot of the second wall member when the second wall member is inverted to form an “x”-shaped divider that divides the interior volume of the tray into four compartments.

26. The signage device of claim 24, wherein the first wall member and the second wall member each include a first edge bead at the top edge and a second edge bead at the bottom edge.

27. The signage device of claim 26, wherein the slot of first wall member and the slot of the second wall member each include an expanded opening at their top edges that generally correspond in shape to and receive and engage the second edge bead of the second wall member and the second edge bead of the first wall member, respectively.

28. The signage device of claim 25, wherein the at least one sign holder includes a first sign holder, a second sign holder, a third sign holder, and a fourth sign holder, each supported by a post; the first wall member and the second wall member each include a first tube at a first end and a second tube at a second end; and, the first tube of the first wall member, the second tube of the first wall member, the first tube of the second wall member, and the second tube of the second wall member receive the post of the first sign holder, the post of the second sign holder, the post of the third sign holder, and the post of the fourth sign holder, respectively.

29. The signage device of claim 25, wherein the first wall member and the second wall member each include a plurality of ventilation slots.

30. A signage device comprising:
at least one support and a panel;
the support rotatably supporting the panel, whereby the panel is free-swinging;
a first surface of the panel having a first “c”-shaped channel for holding a first sign and a second surface of the panel having a second “c”-shaped channel for holding a second sign.

31. The signage device of claim 30, wherein the support includes a proximal segment extending upward from the spring-clip and a distal segment extending perpendicular to the proximal segment, wherein the distal segment engages with the panel.

32. The signage device of claim 31, wherein the panel includes a tubular element that receives the distal segment and the distal segment includes a shoulder that prevents the tubular segment from engaging with an intersection of the proximal segment and distal segment.

33. The signage device of claim 32, wherein the at least one support includes a first support and a second support, the first support engages with the tubular element at a first end of the panel and the second support engages with the tubular element at a second end of the panel.

34. The signage device of claim 32, wherein the first “c”-shaped channel, the second “c”-shaped channel, and the tubular element have a continuous cross-section across an entire length of the panel.

35. The signage device of claim 30, wherein the support has a spring-clip for attaching to a wall of a tray.
